(19) United States
(12) Patent Application Publication
(10) Pub. No.: US 2013/0187771 A1
(43) Pub. Date: Jul. 25, 2013

(54) SYSTEM AND METHOD FOR DISPLAY OF VEHICULAR SEPARATION DISTANCE

(71) Applicant: Leigh M. ROTHSCHILD, Sunny Isles Beach, FL (US)

(72) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/356,143

(22) Filed: Jan. 23, 2012

(51) Int. Cl. B60Q 1/00

(52) U.S. Cl. 340/435

(57) ABSTRACT

Embodiments of the present invention provide a method and system for determining a recommended separation distance between a first vehicle and a second vehicle. In accordance with an embodiment of the present invention, a separation distance between the first vehicle and the second vehicle is determined. A recommended separation distance between the first vehicle and the second vehicle is determined based in part on at least one condition. The separation distance and the recommended separation distance are displayed.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to motor vehicle operation and in particular to a method and system for determining and displaying a recommended separation distance between vehicles.

### BACKGROUND OF THE INVENTION

Many factors contribute to automobile collisions, including automobile failure, roadway design and traffic. Nevertheless, it is estimated that the majority of automobile accidents are due to a driver's behavior, such as aggressive driving, frequent lane changes and following a vehicle too closely. In particular, following a vehicle too closely can be very dangerous, as it gives a driver very little time to react and stop in order to avoid collision with the vehicle in front.

In some situations, a vehicle may be forced to follow too closely, such as when an aggressive driver pulls in front of the vehicle without adequate clearance. The aggressive driver creates a dangerous situation by compelling the vehicle to follow at a dangerous distance. Other times, drivers may follow vehicles a dangerous distance not because they are unaware of the dangers involved, but because they have made tailgating a habit.

The ability to react and take evasive action is greatly increased when travelling at a reasonable recommended separation distance. Keeping a safe distance gives a driver a longer time to react to a problem, and gives the vehicle more time to stop. A recommended vehicle separation distance may depend on different conditions, such as weather conditions, traffic conditions and road conditions. Unfortunately, many drivers may not be aware of what the recommended vehicular separation distance should be or the conditions that should be considered when determining the vehicular separation distance.

What is needed is a method and system for determining and displaying a recommended vehicular separation distance.

### SUMMARY OF THE INVENTION

The present invention advantageously provides a method and system for determining a recommended separation distance between a first vehicle and a second vehicle. In accordance with one aspect, the invention provides a method for determining a separation distance between a first vehicle and a second vehicle. A recommended separation distance between the first vehicle and the second vehicle is determined based in part on at least one condition. The separation distance and the recommended separation distance are displayed.

In accordance with another aspect, the invention provides a system that includes a separation distance apparatus having a processor and a display. The processor determines a separation distance between a first vehicle and a second vehicle. The processor also determines a recommended separation distance between the first vehicle and the second vehicle based in part on at least one condition. The display displays the separation distance and the recommended separation distance.

According to another aspect, the invention provides a tangible computer readable medium storing computer readable instructions that when executed by a processor, cause the processor to perform a method that includes determining a separation distance between a first vehicle and a second vehicle. The method further includes determining a recommended separation distance between the first vehicle and the second vehicle based in part on at least one condition, and displaying the separation distance and the recommended separation distance.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the present invention;

FIG. 2 is a block diagram of an exemplary separation distance apparatus constructed in accordance with the principles of the present invention;

FIG. 3 is a block diagram of an exemplary database according to the principles of the present invention;

FIG. 4 is a block diagram of an exemplary server constructed in accordance with the principles of the present invention; and

FIG. 5 is a flow chart of an exemplary process for determining and displaying a recommended vehicular separation distance, in accordance with the principles of the present invention.

### DETAILED DESCRIPTION OF THE INVENTION

Embodiments of the present invention provide a method, system and separation distance apparatus for determining and displaying a recommended vehicular separation distance. In accordance with an embodiment of the present invention, a separation distance between a first and second vehicle is determined. A recommended separation distance between the first and second vehicle is determined based at least in part on at least one condition. The separation distance and the recommended separation distance are displayed.

Before describing in detail exemplary embodiments that are in accordance with the present invention, it is noted that the embodiments reside primarily in combinations of apparatus components and processing steps related to implementing a method, system and separation distance apparatus for determining and displaying a vehicle separation distance. Accordingly, the method, system and separation distance apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

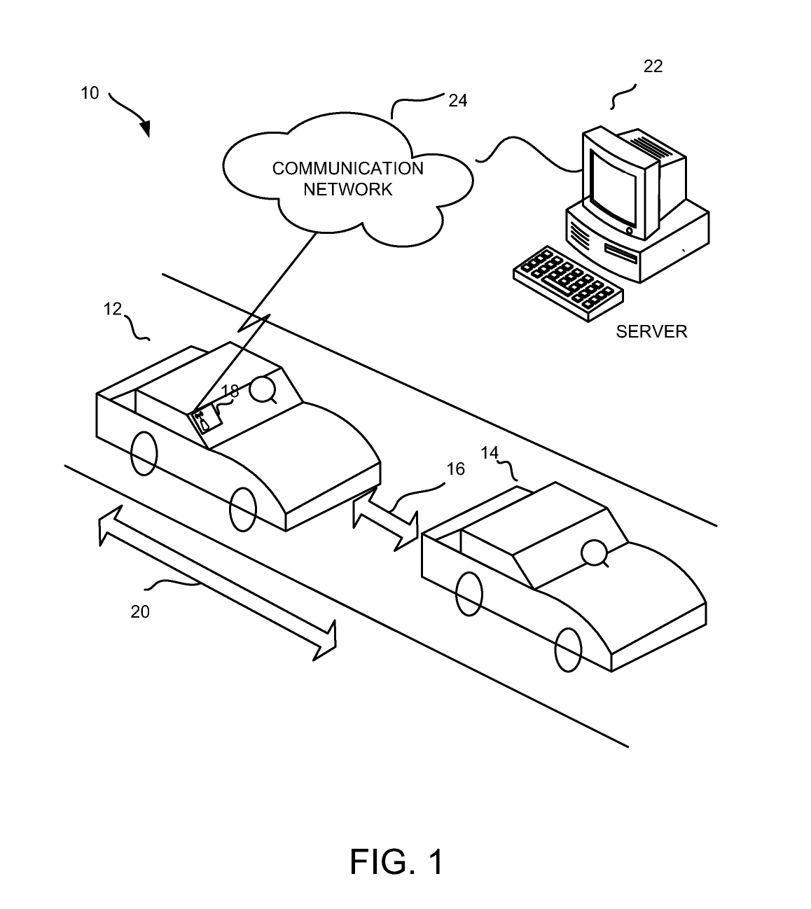

Referring now to the drawing figures in which reference designators refer to like elements, there is shown in FIG. 1 a schematic illustration of a system in accordance with the principles of the present invention, and generally designated as “10”. System 10 includes a first vehicle 12 following a second vehicle 14 with separation distance 16. Separation distance apparatus (“SDA”) 18 may be positionable on or within first vehicle 12. SDA 18 may be a stand-alone device, or integrated as part of a vehicle navigation system, a portable navigation system, a vehicle computer, mobile device, personal computer, laptop computer, tablet computer, PDA, among other types of computers. SDA 18 may determine vehicular separation distance 16. SDA 18 may also determine, based at least in part on at least one condition, a recommended separation distance 20. SDA 18 may display the actual separation distance 16 and recommended separation distance 20.

SDA 18 may be in communication with server 22 via communication network 24. Communication network 24 may include a cellular communication network and the Public Switched Telephone Network (PSTN), or other wide area network (WAN), such as the Internet, as well as local area networks (LANs), such as an Ethernet LAN. Communication network 24 may be a wireless network, such as Wi-Fi, satellite, infrared, Bluetooth, Near Field Communications, or other communications network. SDA 18 and server 22 may be connected via communication network 24 to other computers, such as computers associated with a car manufacturer, a weather service or any other third party (not shown).

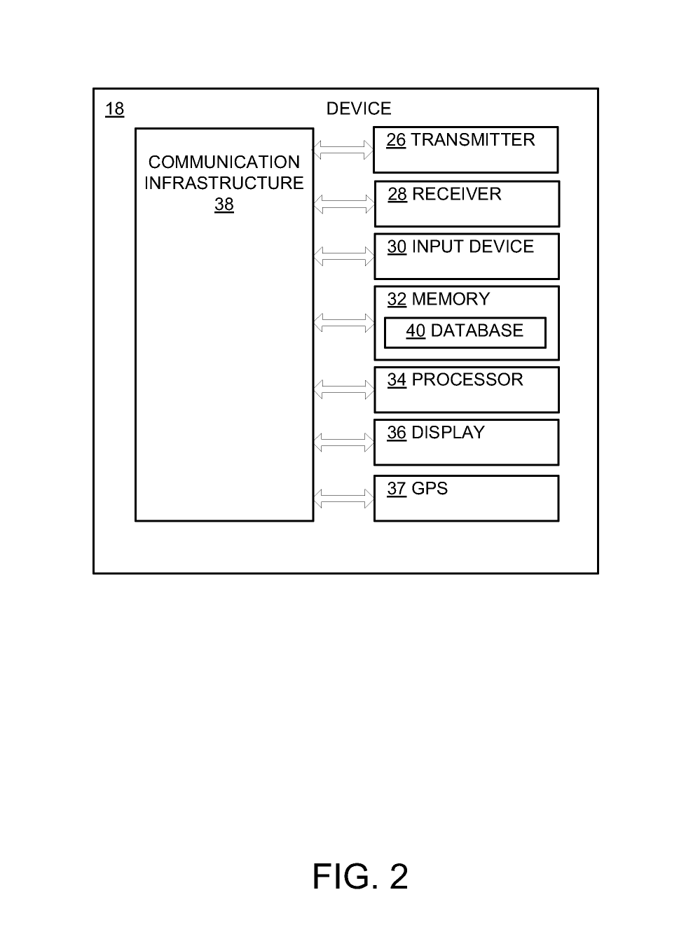

FIG. 2 is a block diagram of an exemplary SDA 18 constructed in accordance with the principles of the present invention. SDA 18 may include transmitter 26, receiver 28, input device 30, memory 32, processor 34, display 36 and global positioning system (“GPS”) unit 37, all connected via communication infrastructure 38. Processor 34 may include a central processing unit (CPU) for performing the functions described herein with respect to SDA 18. Processor 34 is operatively coupled to a communication infrastructure 38, e.g., a communications bus, cross-bar interconnect, network, etc. Input device 30 may be a keyboard, a key pad or a touch pad. SDA 18 may use transmitter 26 and receiver 28 for communicating with server 22 via communication network 24 wireles sly or by wire or optical fiber. Memory 32 may include random access memory (“RAM”) and read only memory (“ROM”). Memory 32 may store database 40. Computer programs (also called computer control logic) may be stored in memory 32. For example, computer programs are stored on memory 32 for execution by processor 34 via RAM, i.e. memory 32. Such computer programs, when executed, enable the method and system to perform the features described herein. In particular, the computer programs, when executed, enable processor 34 to perform functions described herein. Accordingly, such computer programs represent controllers of the corresponding device. Display 36 may be a liquid crystal display (LCD), light-emitting diode (LED) display or touch screen display, among other types of displays.

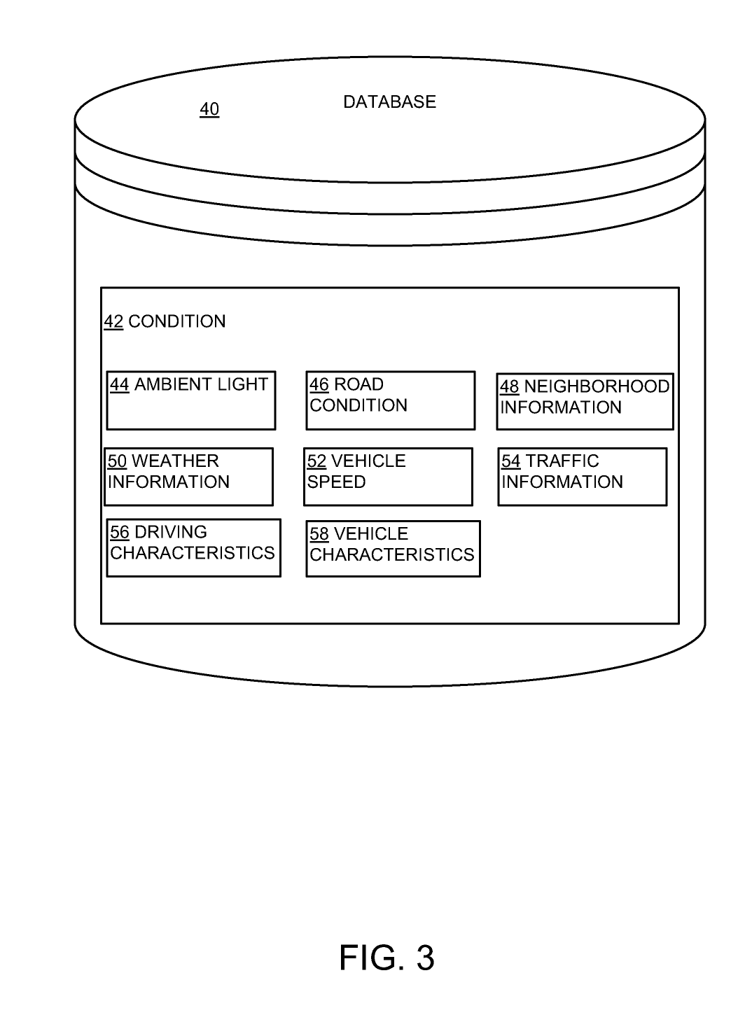

FIG. 3 is a block diagram of an exemplary database 40 constructed in accordance with the principles of the present invention. Database 40 may include at least one condition 42 that may be considered in determining recommended separation distance 20. Condition 42 may include ambient light information 44, road condition information 46, neighborhood information 48, weather information 50, vehicle speed 52, traffic information 54, driving characteristics 56 and vehicle characteristics 58.

Ambient light information 44 includes information about the light conditions outside first vehicle 12. For example, at night, ambient light information 44 may register an absence of light, which indicates that a driver of first vehicle 12 will have low visibility. Ambient light information 44 may also include information about an area in front of first vehicle 12 illuminated by light coming from the headlights of first vehicle 12. The light coming from the headlights influences the visibility of the road, especially at night. Further, ambient light information 44 may also include information about the light inside first vehicle 12 when it is dark outside, as light from interior light sources may make it harder for a driver to see the road ahead.

Road condition information 46 may include information about the road being travelled by first vehicle 12, such as whether the road has narrower not-so-straight lanes, leafy overhanging trees, shrubs and flowers planted close to the lanes and varied surfaces. For example, if the road is very narrow, a larger recommended separation distance 20 may be appropriate, given that first vehicle 12 will not have enough space to maneuver should second vehicle 14 break unexpectedly. Additionally, first vehicle 12 may benefit from a larger recommended separation distance 20 if leafy overhanging trees block the visibility of the road ahead. Road condition information 46 may also include information about whether the road ahead is curvy, downhill, uphill or has lots of turns. Furthermore, road condition information 46 may include a speed limit for the road and whether the road includes potentially risky intersections, such as a railroad crossing, which may require vehicles travelling on the road to stop according to a train schedule. Additionally, road condition information 46 may include information about the road's speed limit, speed bumps ahead, lane narrowing, center islands, raised portions of pavement, traffic lights and regulatory signs, which may influence the calculation of recommended separation distance 20. For example, if road condition information 46 indicates that there are speed bumps ahead, recommended separation distance 20 may increase, given that a speed bump will slow down second vehicle 14, causing first vehicle 12 to break.

Neighborhood information 48 may include information about the neighborhood, such as whether the neighborhood is a residential neighborhood with an elementary school nearby. A road near a school may suggest that a larger recommended separation distance 20 is needed, as children may cross the road unexpectedly in front of second vehicle 14, requiring both first vehicle 12 and second vehicle 14 to stop quickly. Similarly, neighborhood information 48 may include information about whether the road is near bus stops, playgrounds, parks or whether there is significant foot traffic on the road, like on a downtown area. By way of example, a road that is frequently travelled by pedestrians, cyclists, motorcycles, children, school buses, farm vehicles or animals may require recommended separation distance 20 to be larger than for a road that is infrequently used by pedestrians. Also, neighborhood information 48 may include a neighborhood cleaning street schedule, a mail schedule, a delivery schedule, etc. A neighborhood cleaning street schedule may be used to warn first vehicle 12 that a cleaning vehicle and a cleaning crew are working on the road being travelled by first vehicle 12. In this case, recommended separation distance 20 may increase given that first vehicle 12 may be expected to stop for workers without much warning.

Weather information 50 may include information about the weather, such as whether the forecast indicates fog, light rain, heavy rain, freezing rain, slush, snow, sleet, wind, etc. Weather information 50 may also include information as to whether the road ahead is covered by rain, snow or ice, which will make the road slippery. By way of example, recommended separation distance 20 may increase if driving on icy roads, to allow first vehicle 12 to stop safely if second vehicle 14 stops suddenly due to icy conditions. Additionally, weather information 50 may include information about whether there is a possibility of hydroplaning and loosing traction and steering control due to weather conditions. Weather information 50 may further include a weather warning, such as a probability of a hurricane, flood or snowstorms.

Vehicle speed 52 may include a speed at which first vehicle 12 is travelling. For instance, if first vehicle 12 is travelling at a high speed, a driver of first vehicle 12 will have less time to identify hazards and react. Travelling at a high speed may necessitate an increase in the separation distance 20 as it will take first vehicle 12 a longer distance to stop. While a driver travelling at high speeds will have covered more ground in between spotting a hazard and reacting to it, the thinking time that it takes a driver to respond to the hazard is the same. As such, even a small increase in speed can extend the overall stopping distance by a large amount. Since a higher speed means that a driver will have less time to think about how to react to a situation, a larger recommended separation distance may be appropriate.

Traffic information 54 may contain information about traffic patterns and current traffic status. For example, traffic information 54 may include information about the traffic activity ahead, such as an average speed of vehicles and a traffic density. If the traffic is heavy, recommended separation distance 20 may be increased, to give first vehicle 12 a reasonable distance to stop. Additionally, traffic information 54 may include information as to whether there are any accidents, delays or road work ahead. By way of example, traffic information 54 may include information on whether a roadwork zone is dangerous to drive in, whether construction personnel may be working on the driving lane, and whether traffic lanes may have been shifted sideways or may have been completely closed. Traffic information 54 may contain information regarding not only lane closings, traffic barriers and construction equipment ahead, but also about a mobility of a work zone, e.g., whether the work zone is a painting, road patching or mowing working zone that moves up or down a roadway as the work is progressing. Further, traffic information 54 may include information as to whether there are fire, ambulance, police, and other authorized emergency vehicles on the road.

Driving characteristics 56 may include, but not be limited to at least one of an age, gender, reaction time, speeding habits and traffic citations/accidents associated with a driver. Driving characteristics 56 may also include information as to whether the driver is a risky driver that frequently change lanes, passes other vehicles, tailgates, honks and out-maneuvers other vehicles. Aggressive driving practices may require a larger recommended separation distance 20, given the constant braking and accelerating associated with aggressive driving. SDA 18 may monitor a driver's driving and store at least one driving characteristic 56 associated with the driver's driving style in database 40. Driving characteristics 56 may be stored in a driving profile for each driver of first vehicle 12. Driving characteristics 56 may be configured and customized by each driver of first vehicle 12 using input device 30.

Vehicle characteristics 58 may include, but not be limited to a vehicle type, the make and model of first vehicle 12, the shape of first vehicle 12, a maintenance condition of first vehicle 12, safety features of first vehicle 12, such as whether first vehicle 12 has anti-lock brakes, and whether first vehicle 12 is pulling a load, such as a trailer. For example, first vehicle's 12 shape and weight may affect the stopping distance of first vehicle 12. A large and heavy truck may need a larger recommended separation distance 20 than a light and compact car. Vehicle type may include, but is not limited to a pickup truck, a station wagon, a coupe, a sedan, a sport car, a van, a minivan, a sport utility vehicle, a motorcycle, a truck and a boat.

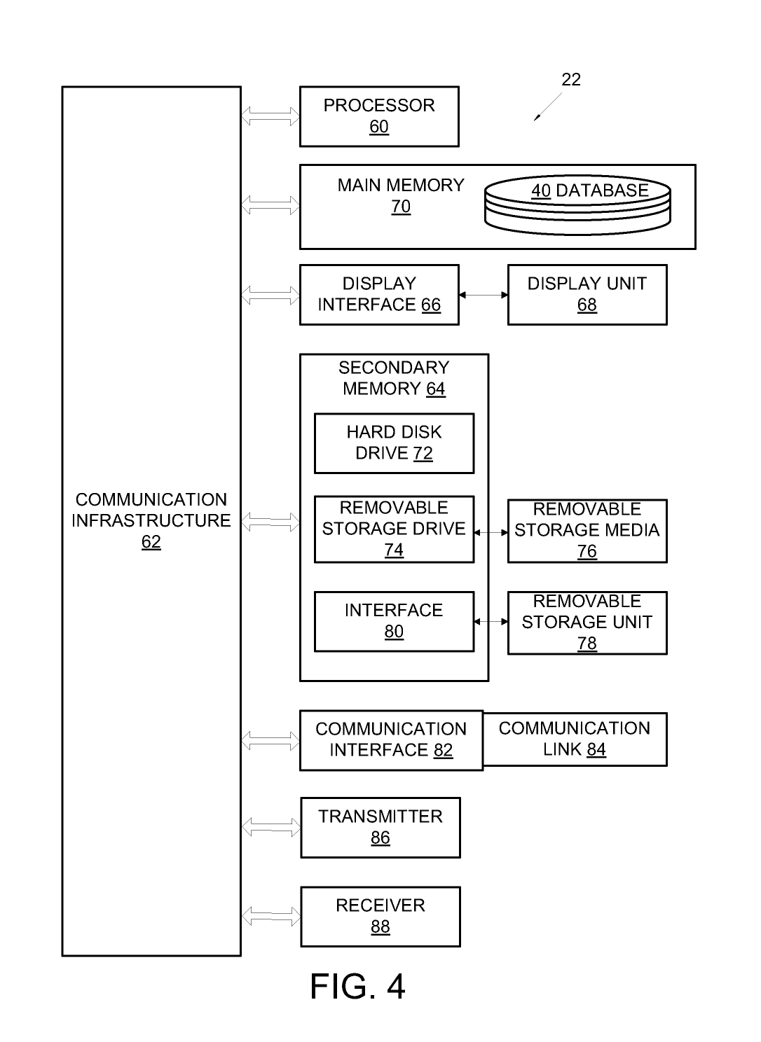

FIG. 4 is a block diagram of an exemplary server constructed in accordance with the principles of the present invention. Server 22 includes one or more processors, such as processor 60 programmed to perform the functions described herein. Processor 60 is operatively coupled to a communication infrastructure 62, e.g., a communications bus, cross-bar interconnect, network, etc. Processor 60 may execute computer programs stored on disk storage for execution via secondary memory 64. Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of server 22 may be designed to occur remotely by web browser. In such case, the inclusion of a display interface and display unit may not be required.

Server 22 may optionally include or share a display interface 66 that forwards graphics, text, and other data from the communication infrastructure 62 (or from a frame buffer not shown) for display on the display unit 68. Display 68 may be a cathode ray tube (CRT) display, liquid crystal display (LCD), light-emitting diode (LED) display, and touch screen display, among other types of displays. The computer system also includes a main memory 70, such as random access memory (“RAM”) and read only memory (“ROM”), and may also include secondary memory 64. Main memory 70 may store database 40.

Secondary memory 64 may include, for example, a hard disk drive 72 and/or a removable storage drive 74, representing a removable hard disk drive, magnetic tape drive, an optical disk drive, a memory stick, etc. The removable storage drive 74 reads from and/or writes to a removable storage media 76 in a manner well known to those having ordinary skill in the art. Removable storage media 76, represents, for example, a floppy disk, external hard disk, magnetic tape, optical disk, etc. which is read by and written to by removable storage drive 74. As will be appreciated, the removable storage media 76 includes a computer usable storage medium having stored therein computer software and/or data.

In alternative embodiments, secondary memory 64 may include other similar devices for allowing computer programs or other instructions to be loaded into the computer system and for storing data. Such devices may include, for example, a removable storage unit 78 and an interface 80. Examples of such may include a program cartridge and cartridge interface (such as that found in video game devices), flash memory, a removable memory chip (such as an EPROM, EEPROM or PROM) and associated socket, and other removable storage units 78 and interfaces 80 which allow software and data to be transferred from the removable storage unit 78 to other devices.

Server 22 may also include a communications interface 82. Communications interface 82 allows software and data to be transferred to external devices. Examples of communications interface 82 may include a modem, a network interface (such as an Ethernet card), a communications port, a PCMCIA slot and card, wireless transceiver/antenna, etc. Software and data transferred via communications interface/module 82 may be, for example, electronic, electromagnetic, optical, or other signals capable of being received by communications interface 82. These signals are provided to communications interface 82 via the communications link (i.e., channel) 84. Channel 84 carries signals and may be implemented using wire or cable, fiber optics, a phone line, a cellular phone link, an RF link, and/or other communications channels.

It is understood that server 22 may have more than one set of communication interface 82 and communication link 84. For example, server 22 may have a communication interface 82/communication link 84 pair to establish a communication zone for wireless communication, a second communication interface 82/communication link 84 pair for low speed, e.g., WLAN, wireless communication, another communication interface 82/communication link 84 pair for communication with low speed wireless networks, and still another communication interface 82/communication link 84 pair for other communication.

Computer programs (also called computer control logic) are stored in main memory 70 and/or secondary memory 64. For example, computer programs are stored on disk storage, i.e. secondary memory 64, for execution by processor 60 via RAM, i.e. main memory 70. Computer programs may also be received via communications interface 82. Such computer programs, when executed, enable the method and system to perform the features of the present invention as discussed herein. In particular, the computer programs, when executed, enable processor 60 to perform the features of the corresponding method and system. Accordingly, such computer programs represent controllers of the corresponding device. Server 22 also includes transmitter 86 and receiver 88. Processor 60 communicates with transmitter 86 and receiver 88 via communication infrastructure 62. Server 22 may communicate with SDA 18 via communication network 24.

In an exemplary embodiment, processor 34 determines recommended separation distance 20. Processor 34 may query database 40 in memory 32 to obtain at least one condition 42 that may be used to determine recommended separation distance 20. Processor 34 may determine recommended separation distance 20 between first vehicle 12 and second vehicle 14 based in part on at least one condition 42. Processor 34 may determine recommended separation distance 20 based in part on at least one of ambient light information 44, road condition information 46, neighborhood information 48, weather information 50, vehicle speed 52, traffic information 54, driving characteristics 56 and vehicle characteristics 58. Display 36 may display separation distance 16 and recommended separation distance 20.

In another exemplary embodiment, SDA 18 may receive from server 22 at least one condition 42. Memory 70 may store database 40 containing condition 42. Processor 34 may determine separation distance 16. Transmitter 26 may send to server 22 a request requesting server 22 to send at least one condition 42. Receiver 88 may receive the request. Processor 60 may query database 40 in memory 70 to obtain at least one condition 42. Transmitter 86 may transmit at least one condition 42 to receiver 28 in SDA 18. For example, condition 42 may include at least one of ambient light information 44, road condition information 46, neighborhood information 48, weather information 50, vehicle speed 52, traffic information 54, driving characteristics 56 and vehicle characteristics 58.

Processor 34 may determine recommended separation distance 20 between first vehicle 12 and second vehicle 14 based in part on condition 42. Processor 34 may determine recommended separation distance 20 based in part on at least one of ambient light information 44, road condition information 46, neighborhood information 48, weather information 50, vehicle speed 52, traffic information 54, at least one driving characteristic 56 and at least one vehicle characteristic 58. Display 36 may display separation distance 16 and recommended separation distance 20.

In another exemplary embodiment, SDA 18 may receive a recommended separation distance 20 from server 22. Processor 34 may determine separation distance 16. Transmitter 26 may send to server 22 a request for recommended separation distance 20. Receiver 88 may receive the request. Processor 60 may query database 40 in memory 70 and may determine recommended separation distance 20 between first vehicle 12 and second vehicle 14 based in part on at least one condition 42. Processor 60 may determine recommended separation distance 20 based in part on at least one of ambient light information 44, road condition information 46, neighborhood information 48, weather information 50, vehicle speed 52, traffic information 54, at least one driving characteristic 56 and at least one vehicle characteristic 58. Transmitter 86 may transmit recommended separation distance 20 to receiver 28. Display 36 may display separation distance 16 and recommended separation distance 20.

In another exemplary embodiment, SDA 18 may determine that first vehicle 12 is being followed too closely. SDA 18 may determine that second vehicle 14 is following first vehicle 12 at a separation distance that is less than the recommended separation distance. SDA 18 may notify first vehicle 12 that second vehicle 14 is following first vehicle 12 too closely. SDA 18 may display a warning, such as a warning message on display 36. SDA 18 may display the current separation distance 16 and recommended separation distance 20 and/or a speed needed to achieve the desired distance within a predetermined period of time. SDA 18 may also signal first vehicle 12 to, for example, speed up, move to a different lane or pull over. SDA 18 may also display a message on display 36 advising first vehicle 12 to move to another lane if possible or pull off the road to let the vehicle following first vehicle 12 pass.

In another exemplary embodiment, SDA 18 may determine that first vehicle 12 is following second vehicle 14 too closely. SDA 18 may determine that first vehicle 12 is following second vehicle 14 at a separation distance that is less than the recommended separation distance. SDA 18 may notify first vehicle 12 that it is following second vehicle 14 too closely. SDA 18 may display a warning, such as a warning message on display 36. SDA 18 may advise first vehicle 12 to slow down or move to a different lane. When first vehicle 12 follows second vehicle 14 at a proper distance, i.e. at recommended separation distance 20, first vehicle 12 may consume less fuel, as first vehicle 12 may not need to brake as often when second vehicle 14 slows down.

In another exemplary embodiment, first vehicle 12 may communicate with other vehicles, including second vehicle 14. First vehicle 12 may use SDA 18, a cell phone, a PDA, a computer, or any other device to communicate with second vehicle 14 via Wi-Fi, satellite, infrared, Bluetooth, Near Field Communications, or other communication network. SDA 18 may communicate with second vehicle 14 using receiver 28 and transmitter 26. First vehicle 12 may use a communication device or SDA 18 to notify second vehicle 14 that current separation distance 16 is less than recommended separation distance 20. By way of example, if second vehicle 14 is following first vehicle 12 too closely, i.e. separation distance 16 is less than recommended separation distance 20, SDA 18 may send a message to a driver of second vehicle 14. The message may notify second vehicle 14 that the current separation distance 16 is less than recommended separation distance 20. The message may suggest that second vehicle 14 slow down and/or change lanes. SDA 18 may also notify a driver of first vehicle 12 of the situation and may suggest first vehicle 12 to speed up and/or move to another lane to let second vehicle 14 pass.

In another exemplary embodiment, processor 34 may analyze at least one condition 42 and display warning messages on display 36. For example, processor 34 may analyze traffic information 54 and determine that there is construction on the road. SDA 18 may display a message suggesting a detour that allows first vehicle 12 to avoid the work zone. As another example, SDA 18 may determine that first vehicle 12 is driving at too high a vehicle speed 52, when considering road condition information 46 and weather information 50. SDA 18 may also calculate a time it will take first vehicle 12 to catch up with second vehicle 14.

In another exemplary embodiment, a driver of first vehicle 12 may use input device 30 to enter information into database 40, such as driving characteristics 56 or vehicle characteristics 58. For example, the driver may enter the number of accidents the driver has been involved in, or whether first vehicle 12 is pulling a large load. Additionally, a driver may use input device 30 to enter profile information, such as a driver's name, driver license number, age, etc. A driver's profile may be stored in database 40.

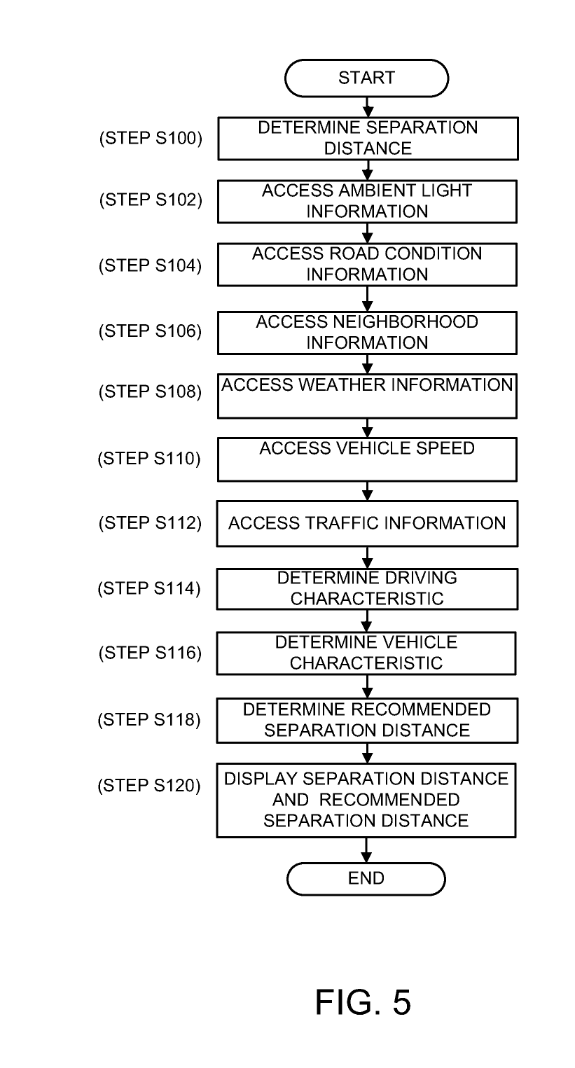

FIG. 5 is a flow chart of an exemplary process for determining recommended separation distance 20 between first vehicle 12 and second vehicle 14, in accordance with the principles of the present invention. A current separation distance 16 between first vehicle 12 and second vehicle 14 may be determined (Step S 100). Methods for generally determining distances between vehicles are known. Known methods include determining distances using sonars, lasers, digital imaging, and radars. By way of example, sensors may be interior or exterior motion sensors. Sensors may detect obstacles and motion around first vehicle 12. Sensor may measure separation distance 20 between first vehicle 12 and second vehicle 14. Sensors may be, but are not limited to, short range sensors, long range sensors, analog sensors, digital sensors, sonic, infrared and photoelectric sensors. In one embodiment, a sensor may be located at the front of first vehicle 12, such as on a front bumper of first vehicle 12, and may measure the distance between first vehicle 12 and second vehicle 14 when second vehicle 14 is in front of first vehicle 12. In another embodiment, a sensor may be located at the back of first vehicle 12, such as on a rear bumper of first vehicle 12, and may measure the distance between first vehicle 12 and second vehicle 14 when first vehicle 12 is being followed by second vehicle 14.

Ambient light information 44, road condition information 46 and neighborhood information 48 may be accessed (Steps S102, S104 and S106). Additionally, weather information 50, vehicle speed 52, traffic information 54 may also be accessed (Step S108, S110 and S 112). At least one driving characteristic 56 and at least one vehicle characteristic 58 may be determined (Steps S114 and S116). A recommended separation distance 20 between first vehicle 12 and second vehicle 14 is determined (Step S118). Recommended separation distance 20 may be determined based in part on at least one condition, such as ambient light information 44, road condition information 46, neighborhood information 48, weather information 50, vehicle speed 52, traffic information 54, at least one driving characteristic 56 and at least one vehicle characteristic 58. Separation distance 16 and recommended separation distance 20 are displayed (Step S120). Although Steps 5102 through 5116 are shown in FIG. 5, the invention is not limited to such. Only one or more of Steps S102-S116 need to be considered and the steps do not need to be executed in the order shown.

The present invention can be realized in hardware or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program, software or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method, comprising:
determining a separation distance between a first vehicle and a second vehicle;
determining a recommended separation distance between the first vehicle and the second vehicle based in part on at least one condition; and
displaying the separation distance and the recommended separation distance.

2. The method of claim 1, wherein determining the recommended separation distance further comprises:
accessing weather information; and
determining the recommended separation distance based at least in part on the weather information.

3. The method of claim 1, wherein determining the recommended separation distance further comprises:
accessing at least one of road condition information and ambient light information; and
determining the recommended separation distance based at least in part on the at least one of road condition information and ambient light information.

4. The method of claim 1, wherein determining the recommended separation distance further comprises:
determining at least one of a first vehicle speed and a first vehicle safety feature; and
determining the recommended separation distance based at least in part on the at least one of the first vehicle speed and the first vehicle safety feature.

5. The method of claim 1, wherein determining the recommended separation distance further comprises:
accessing neighborhood information; and
determining the recommended separation distance based at least in part on the neighborhood information.

6. The method of claim 1, wherein determining the recommended separation distance further comprises:
accessing traffic information; and
determining the recommended separation distance based at least in part on the traffic information.

7. The method of claim 1, wherein determining the recommended separation distance further comprises:
determining at least one driving characteristic of a driver of the first vehicle; and
determining the recommended separation distance based at least in part on the at least one driving characteristic.

8. The method of claim 1, wherein determining the recommended separation distance further comprises:
determining at least one vehicle characteristic of the first vehicle; and
determining the recommended separation distance based at least in part on the at least one vehicle characteristic.

9. The method of claim 1, further comprising:
displaying a warning when the separation distance is less than the recommended separation distance.

10. The method of claim 1, further comprising:
determining the first vehicle is following the second vehicle; and
determining that the separation distance between the first vehicle and the second vehicle is less than the recommended separation distance; and
notifying the first vehicle that the first vehicle is following the second vehicle too closely.

11. The method of claim 1, further comprising:
determining the second vehicle is following the first vehicle;
determining that the separation distance between the first vehicle and the second vehicle is less than the recommended separation distance; and
notifying the first vehicle that the second vehicle is following the first vehicle too closely.

12. A system, comprising:
a separation distance apparatus, the separation distance apparatus having:
a processor, the processor:
determining a separation distance between a first vehicle and a second vehicle; and
determining a recommended separation distance between the first vehicle and the second vehicle based in part on at least one condition; and
a display in communication with the processor, the display:
displaying the separation distance and the recommended separation distance.

13. The system of claim 12, the processor further:
accessing weather information; and
determining the recommended separation distance based at least in part on the weather information.

14. The system of claim 12, the processor further:
accessing at least one of road condition information and ambient light information; and
determining the recommended separation distance based at least in part on the at least one of road condition information and ambient light information.

15. The system of claim 12, the display further displaying a warning message when the separation distance is less than the recommended separation distance.

16. The system of claim 12, the processor further:
determining at least one of a first vehicle speed and a first vehicle safety feature; and
determining the recommended separation distance based at least in part on the at least one of the first vehicle speed and a the first vehicle safety feature.

17. The system of claim 12, the processor further:
determining the first vehicle is following the second vehicle; and
determining that the separation distance between the first vehicle and the second vehicle is less than the recommended separation distance; and
notifying the first vehicle that the first vehicle is following the second vehicle too closely.

18. The system of claim 12, the processor further:
determining the second vehicle is following the first vehicle;
determining that the separation distance between the first vehicle and the second vehicle is less than the recommended separation distance; and
notifying the first vehicle that the second vehicle is following the first vehicle too closely.

19. The system of claim 12, further comprising a server in communication with the separation distance apparatus, the server having:
a memory, the memory storing at least one condition in a database, the condition including at least one of weather information, road condition information, ambient light information, a first vehicle speed and a first vehicle safety feature; and
a transmitter in communication with the memory, the transmitter transmitting the at least one condition to the separation distance apparatus.

20. A tangible computer readable medium storing computer readable instructions that when executed by a processor, cause the processor to perform a method comprising:
determining a separation distance between a first vehicle and a second vehicle;
determining a recommended separation distance between the first vehicle and the second vehicle based in part on at least one condition; and
displaying the separation distance and the recommended separation distance.

21. The tangible computer readable medium of claim 20, wherein determining the recommended separation distance further comprises:
accessing weather information; and
determining the recommended separation distance based at least in part on the weather information.

22. The tangible computer readable medium of claim 20, wherein determining the recommended separation distance further comprises:
accessing at least one of road condition information and ambient light information; and
determining the recommended separation distance based at least in part on the at least one of road condition information and ambient light information.

23. The tangible computer readable medium of claim 20, wherein determining the recommended separation distance further comprises:
determining at least one of a first vehicle speed and a first vehicle safety feature; and
determining the recommended separation distance based at least in part on the at least one of the first vehicle speed and the first vehicle safety feature.

24. The tangible computer readable medium of claim 20, the method further comprising:
displaying a warning message when the separation distance is less than the recommended separation distance.
